(19) United States
(12) Patent Application Publication
(10) Pub. No.: US 2004/0144022 A1
(43) Pub. Date: Jul. 29, 2004

(54) Method and apparatus for providing a retractable barrier for protection from inclement weather

(76) Inventor: Marcia Mink Roebuck, Houston, TX (US)

Correspondence Address: G. Michael Roebuck, 8407 Bluegate Court, Houston, TX, 77023, US

(21) Appl. No.: 10/365,543

(22) Filed: Jan. 27, 2003

(51) Int. Cl. A01G 13/02

(52) U.S. Cl. 47/29.1

(57) ABSTRACT

The present invention provides a retractable material forming a protective barrier that can be deployed in furled condition in temperate weather and quickly unfurled during or before or after inclement weather arrives. The retractable material provided by the present invention can be utilized to protect fruits, plants, animals, and tender vegetation from cold weather by forming a thermal insulating barrier.

### BACKGROUND OF THE INVENTION

1. Field of the Invention

The present invention relates to the provision of a retractable barrier for shrubbery and vegetation.

2. Background of the Related Art

Non fruit-bearing trees normally are not harmed by freezing cold, however, the vegetation surrounding a non-fruit bearing tree typically is more susceptible to freezing. Sudden cold snaps can catch gardeners off guard and create a hasty pursuit in inclement or freezing conditions in an attempt to cover and protect the vegetation surrounding a tree. Thus, there is a need for a retractable thermal barrier that can be deployed and stored in a furled condition in warm weather and quickly unfurled during or before a cold snap in the weather. There is also a need for a protective thermal barrier, which can be deployed to protect fruit-bearing trees.

### SUMMARY OF THE INVENTION

The present invention provides a retractable material forming a protective barrier that can be deployed in furled condition in temperate weather and quickly unfurled during or before or after inclement weather arrives. The retractable material provided by the present invention can be utilized to protect animals, fruits, plants, animals, and tender vegetation from cold weather by forming a thermal insulating barrier. The retractable material provided by the present invention can be utilized to protect animals, fruits, plants, animals, and tender vegetation from heat of the sun by forming a shade source. The retractable material provided by the present invention can be utilized to protect fruits, plants, animals, and tender vegetation from the rain by forming a waterproof barrier. The retractable material provided by the present invention can be utilized to protect fruits, plants, animals, and tender vegetation from destructive forces of wind. The retractable material provided by the present invention can be utilized to provide fruits, plants, animals, and tender vegetation with a semi-permeable cover that allows only a portion of water from heavy rain through to plants underneath the barrier so that tender vegetation is misted rather than drowned in the deluge of a torrential downpour during a rainstorm. The retractable material provided by the present invention can be utilized to protect fruits, plants, animals, and tender vegetation from sand storms. In one embodiment the present invention fits snugly and slidably around the trunk of a tree where it is rolled up in a furled condition until needed. The furled barrier can be slide down the tree trunk or central support to reduce visibility of the furled material or to hid the furled material behind plants surrounding the tree or support. When undesirable weather conditions such as extreme cold weather, rain, wind, sand storms or extreme sun is imminent the retractable thermal insulating material present invention is unfurled radial from the tree trunk to cover vegetation surrounding the tree trunk. In an alternative embodiment of the present invention, a retractable thermal is deployed from a rigid or semi-rigid support structure so that the protective thermal barrier can be deployed without a tree trunk. The semi-rigid support comprises a central support pole formed of wood, metal, plastic or inflatable material, which can be filled with water or air. The present invention can also be used as a tent to protect humans from the elements. In another embodiment, the retractable barrier is deployed out substantially horizontally out from a from a vertical wall to the ground over plants, vegetation or animals for protection from the elements.

### BRIEF DESCRIPTION OF THE DRAWINGS

FIG. 1 illustrates a preferred embodiment of the present invention deployed on a tree trunk in an unfurled condition;

FIG. 2 illustrates an alternative embodiment of the present invention deployed from a central support in an unfurled condition covering plants surrounding the central support;

FIG. 3 illustrates an alternative embodiment of the present invention deployed horizontally from a vertical wall;

FIG. 4 a preferred embodiment of the present invention in a furled condition;

FIG. 5A illustrates a bottom view of a section of the barrier material provided by the present invention;

FIG. 5B illustrates a bottom view of a section of the barrier material having a substantially triangular or trapezoid shape provided by the present invention;

FIG. 6 illustrates a top view of a section of the barrier material provided by the present invention; and

FIG. 7 illustrates a Velcro strip at the edge of a section to adhering to an adjacent section.

### DETAILED DESCRIPTION OF A PREFERRED EMBODIMENT

The present invention provides a retractable material forming a protective barrier that can be deployed in furled condition for storage in temperate weather and quickly unfurled to form a protective barrier during or before or after inclement weather arrives. The retractable material provided by the present invention can be utilized to protect fruits, plants, animals, and tender vegetation from cold weather by forming a thermal insulating barrier. The retractable material provided by the present invention can be utilized to protect fruits, plants, animals, and tender vegetation from heat of the sun by forming a shade source. The retractable material provided by the present invention can be utilized to protect fruits, plants, animals, and tender vegetation from the rain by forming a waterproof barrier. The retractable material provided by the present invention can be utilized to protect fruits, plants, animals, and tender vegetation from destructive forces of wind. The retractable material provided by the present invention can be utilized to provide fruits, plants, animals, and tender vegetation with a semi-permeable cover that allows only a portion of water from heavy rain through to plants underneath the barrier so that tender vegetation is misted rather than drowned in the deluge of a torrential downpour during a rainstorm. The retractable material provided by the present invention can be utilized to protect fruits, plants, animals, and tender vegetation from sand storms. In one embodiment the present invention fits snugly around the trunk of a tree where it is rolled up in a furled condition until needed. When undesirable weather conditions such as extreme cold weather, rain, wind, sand storms or extreme sun is imminent the retractable thermal insulating material present invention is unfurled radial from the tree trunk to cover vegetation surrounding the tree trunk.

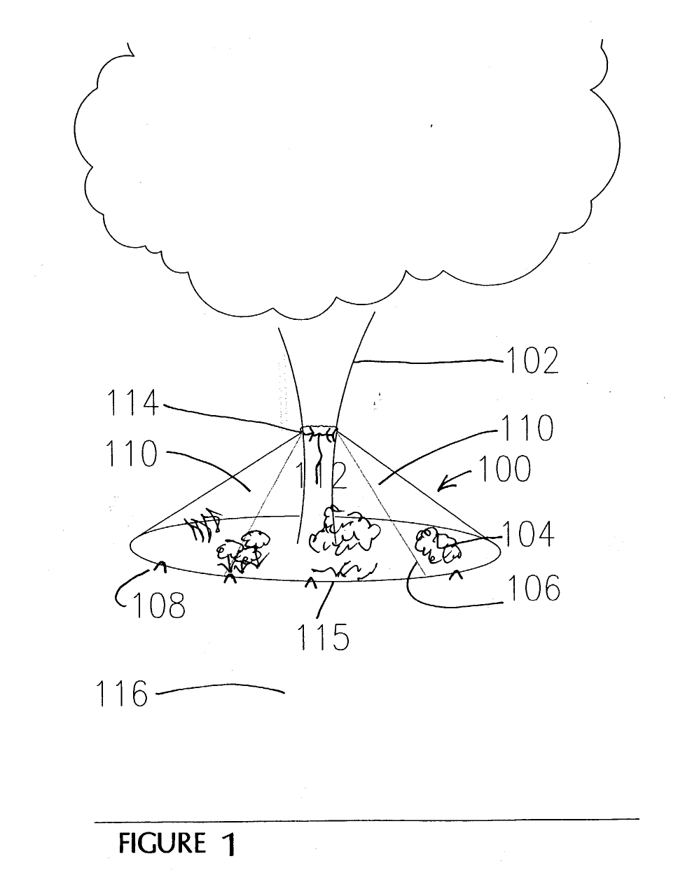

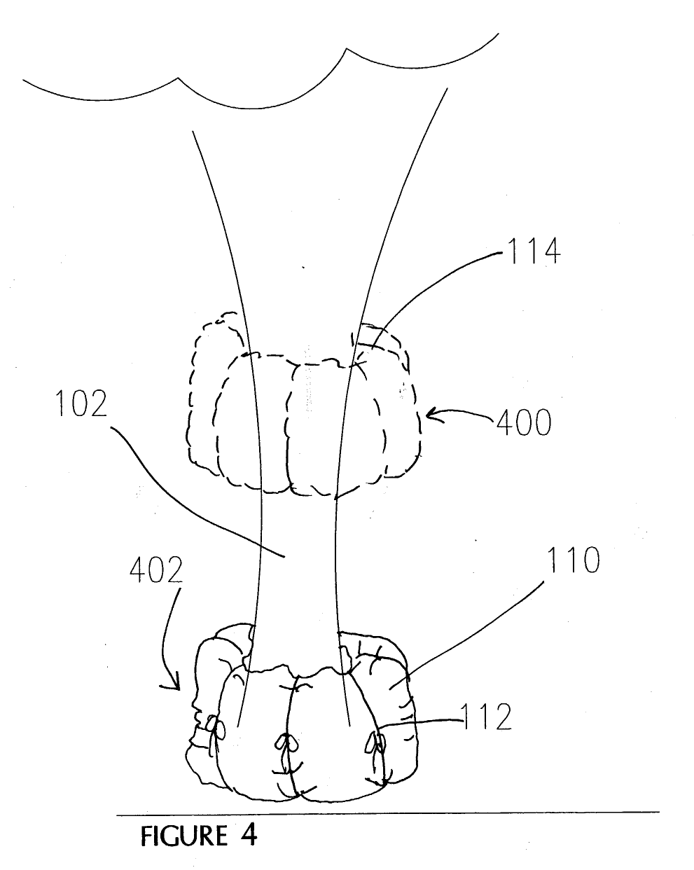

In an alternative embodiment of the present invention, a retractable thermal is deployed from a rigid or semi-rigid support structure so that the protective thermal barrier can be deployed without a tree trunk. The semi-rigid support comprises a central support pole formed of wood, metal plastic or inflatable material, which can be filled with water or air. FIG. 1 illustrates a preferred embodiment of the present invention 100 deployed from a tree trunk 102 in an unfurled condition. As shown in FIG. 1, in a preferred embodiment of the present invention comprises a protective material comprised of a plurality of material sections 110 which are joined at adjacent edges 106. The edges 106 are fixably attached together for example, by Velcro strips, fasteners, clips, sewn together or simply overlap to form a barrier or continuum of protective material when viewed from above. The continuum of material forms a protective barrier for the plants 104 or animals underneath sections 110. The top ends 114 of the material sections 110 are snuggly fitted around the tree trunk to form a frictional bond constituting a seal 114 for the barrier from cold, heat, water, said or air against the tree trunk to keep cold air and other inclement weather elements from the vegetation 104 underneath the protective barrier formed by the aggregation of the material sections 110. The tops 114 are elastic or releasable tie strings, cords or detachable fasteners to enable loosening of the seal at the top 114 so that the tops 114 can be slid up and down the tree trunk or support from which the sections 110 depend. The furled material is slid down the support or tree trunk during storage in a furled condition to reduce visibility of the furled material and slid up the support or tree trunk for deployment in an unfurled condition. The bottom end 115 of each section 110 is attached to the ground by landscape anchors 108, or other means such as weights or sand. Strings 112 velcro, ties, fasteners or pins are provided at the top 114 of each section 110 so that each section 110 can be rolled up or furled, stored and tied in a rolled up configuration by string 112 for storage adjacent the tree trunk 102, support 202 or support 302. As shown in FIG. 4, the furled sections 110 can be slid down the tree trunk to the bottom of the tree to reduce visibility.

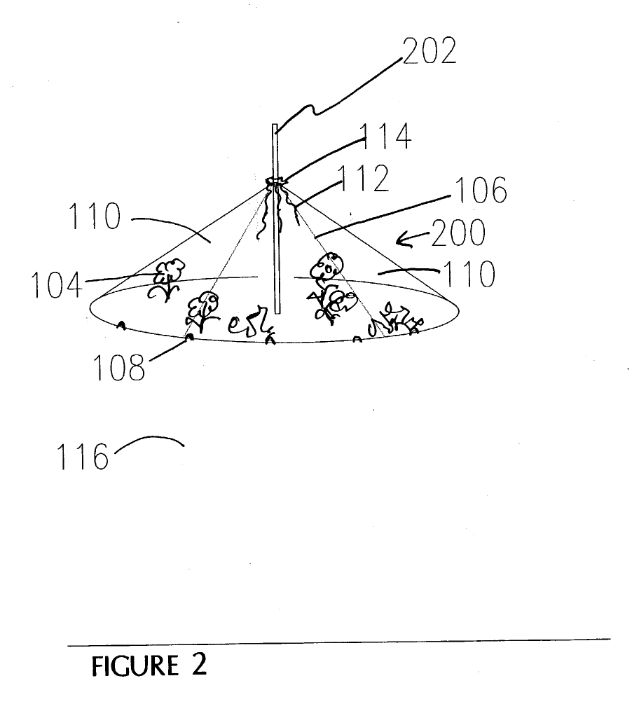

FIG. 2 illustrates an alternative embodiment of the present invention deployed on a central support 202 in an unfurled condition covering plants 104 surrounding the central support 202. As shown in FIG. 2 an alternative embodiment of the present invention 200 is deployed from a central support 202 in an unfurled condition. As shown in FIG. 2, in an alternative embodiment of the present invention comprises a protective material comprised of a plurality of material sections 110 which are joined at adjacent edges 106. The side edges 106 of each adjacent section 110 are releasably attached together for example, by Velcro strips, clips, pins, sewn together or simply overlapped to form a barrier comprising a continuum of material when viewed from above. The top end 114 of the material sections 110 are snuggly fitted and slidably attached around the central support to form a frictional bond constituting a barrier or seal 114 to keep out the weather elements by snuggly fitting against the central support to keep cold air and other inclement weather elements from the vegetation 104 or animals underneath the protective barrier formed by the aggregation of the material sections 110. The bottom of the sections 110 are attached to the ground by anchors 108. Clips, fasteners, or strings 112 are provided at the top 114 of each section 110 so that each section 110 can be rolled up or furled and tied in a rolled up configuration by string 112 for storage adjacent the central support 202. The furled sections 110 can be slid down the central support 202 or tree trunk 102 to the bottom of the support 202 tree trunk 102 to reduce visibility during storage and to provide a variable height of deployment from a tree trunk 102, central support 202 or vertical support 302.

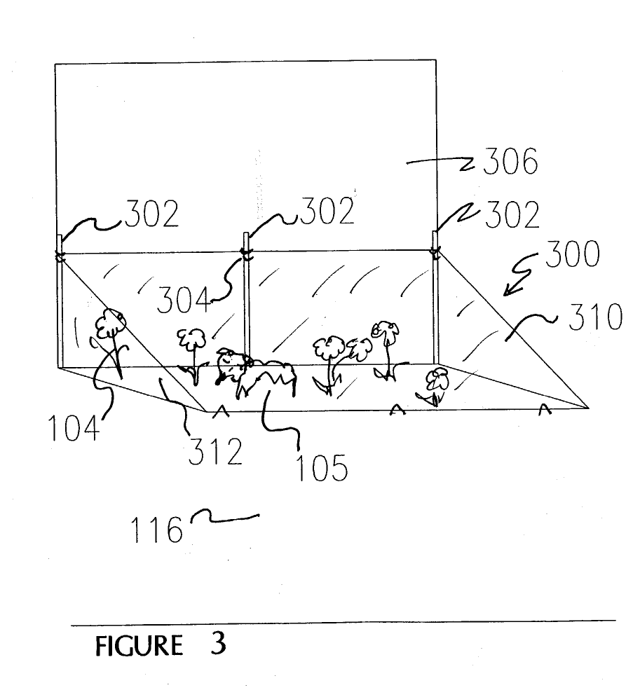

FIG. 3 illustrates an alternative embodiment of the present invention deployed horizontally from a wall 306 such as from a wall of a home for extension over a flowerbed 312 of plants 104 or animals 105 adjacent the wall 306. The material forms a barrier overt the flower bed or animals and is comprised of one or more sections 310 to cover the plants and draped over the ends 312 of the structure to form a barrier at each end of the section 310. The barrier formed by section 310 and 312 is fastened to the ground by pins, clips, anchors, sand, weights or stakes. The sections 310 and 312 are furled to the wall and slid down supports 302 behind plants 104 for storage and to reduce visibility.

FIG. 4 illustrates the present invention as illustrated in FIG. 1, but in a furled condition 400. Each section 110 is rolled up or furled and preferably fastened or tied by string 112 or fastener. The furled sections are simply tied for storage at the elevation on the tree trunk 102 of seal 114 or slid down out of sight at the bottom of the tree trunk at position 402.

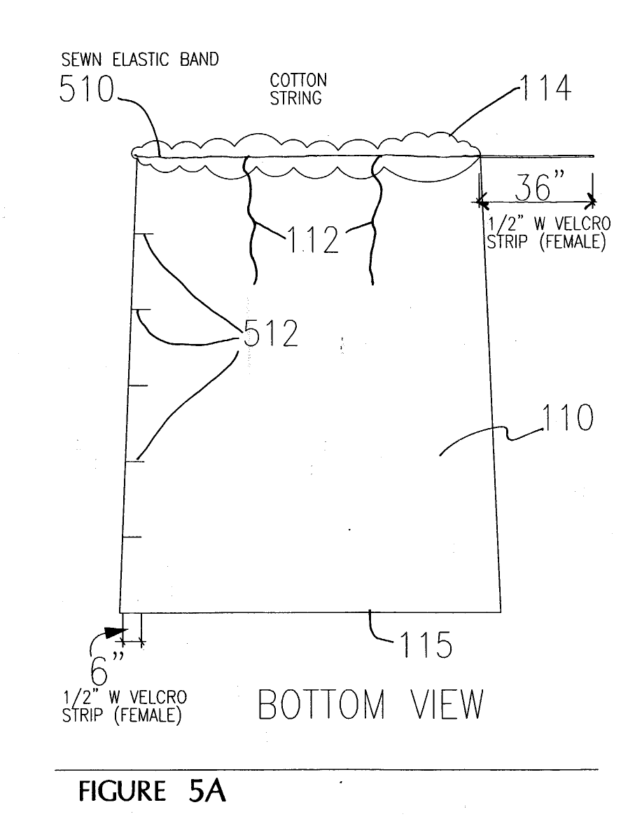

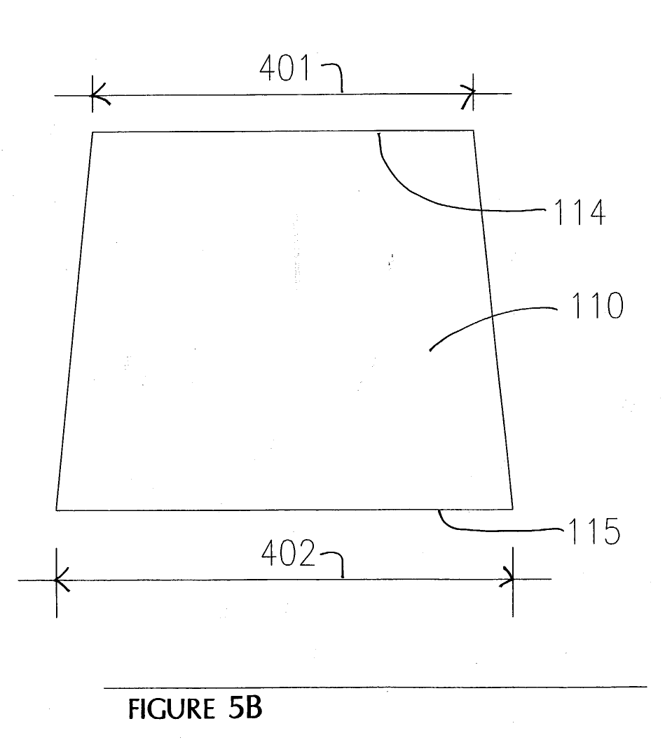

FIG. 5. illustrates a bottom view of a section 110 of the barrier material provided by the present invention. Each section 110 is fitted with an elastic band 510 at the top 114 of section 110 so that the top of the section 114 fits snuggly against the tree trunk. Alternatively the elastic band 510 can be replaced with a string, cord or releasable fastener that slidably secures the top 114 of the section 110 to the tree trunk 102, central support 202 or vertical wall support 302. FIG. 5A illustrates Velcro strips 512 provided at the edge of a section 110 for adhering to an adjacent section 110. FIG. 5B illustrates an alternative embodiment of the present invention wherein the section 110 bottom width 402 is wider than section 110 top width 401.

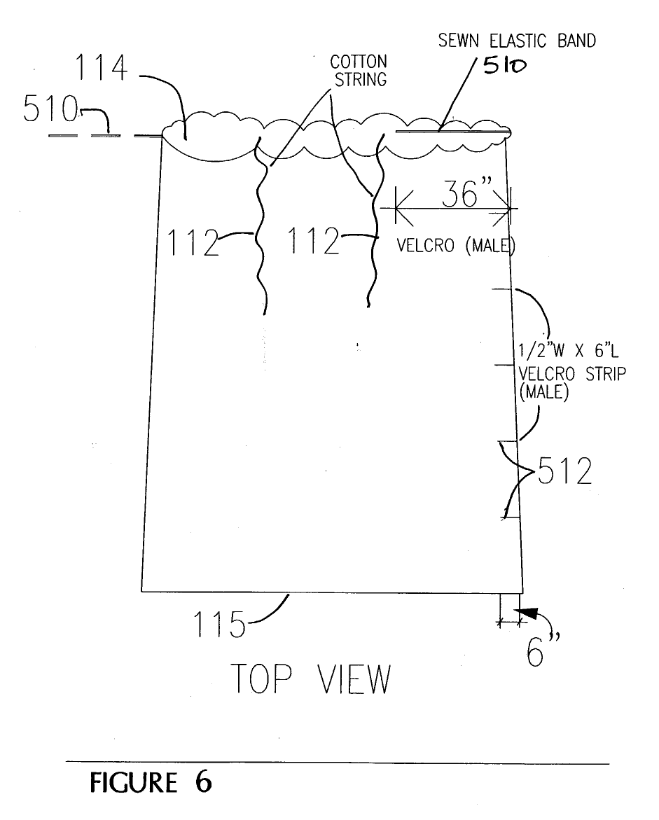

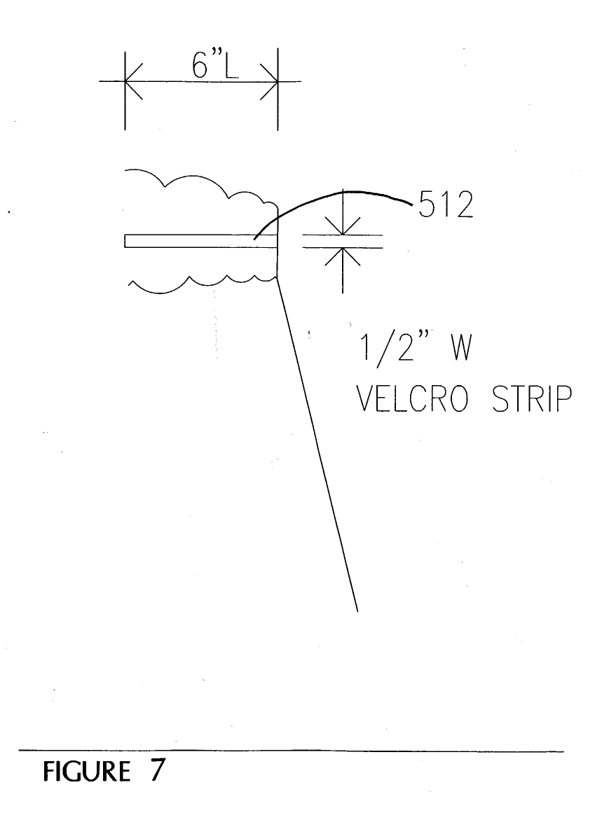

FIG. 6 illustrates a bottom view of a section 110 of the barrier material provided by the present invention. Each section 110 is fitted with an elastic band 510 so that the top of the section 114 fits snuggly against the tree trunk. Alternatively the elastic band 510 can be replaced with a string or cord that secures the top 114 of the section 110. FIG. 5 illustrates Velcro strips 512 provided at the edge of a section 110 for adhering to an adjacent section 110. FIG. 7 illustrates an enlarged view of the Velcro strip 512.

While the foregoing disclosure is directed to the preferred embodiments of the invention various modifications will be apparent to those skilled in the art. It is intended that all variations within the scope and spirit of the appended claims be embraced by the foregoing disclosure. Examples of the more important features of the invention have been summarized rather broadly in order that the detailed description thereof that follows may be better understood, and in order that the contributions to the art may be appreciated. There are, of course, additional features of the invention that will be described hereinafter and which will form the subject of the claims appended hereto.

1. An apparatus protecting vegetation comprising:
a retractable material for forming a barrier for protecting vegetation or animals underneath the barrier; and
a support for supporting the retractable material from which to suspend the retractable material above vegetation or animals for protection from weather elements.

2. The apparatus of claim 1, wherein the retractable material is extendable in a radial direction form the support and above vegetation from the support.

3. The apparatus of claim 2, wherein the retractable material is retractable to the support for storage.

4. The apparatus of claim 1, wherein the material is extendable at an angle from a vertical support to a ground surface.

5. The apparatus of claim 1, further comprising:
a slidable attachment for slidably attaching the material to the support.

6. The apparatus of claim 1, wherein the material further comprises a plurality of section joined at adjacent sides to form a barrier.

7. The apparatus of claim 1, wherein the material is stored in a furled adjacent the support.

8. The apparatus of claim 7, wherein the furled material is slid down the support.

9. The apparatus of claim 1, further comprising:
fasteners at an end of the material for the material to a ground surface.

10. The apparatus of claim 1, further comprising:
a slidable fastener for slidably attaching an end of the material to the support.

11. The apparatus of claim 1, further comprising:
Fasteners for attaching a distal end of the materials form the support to the ground.

12. An apparatus for protection plants and animals from weather elements comprising:
a retractable barrier means for unfurling over vegetation or animals for protection from weather elements; and
a support means for supporting the barrier above the vegetation or animals.

13. The apparatus of claims 12, further comprising:
slidable attachment means for slidably attaching the barrier to the support means for sliding the barrier down to the ground in a furled condition for storage.

14. The apparatus of claim 13, further comprising:
Attachment means for joining a plurality of edges of at least one section together to form a barrier.

15. A method for protecting vegetation surround a tree from cold weather comprising:
Attaching a material to a vertical support; and
Deploying the thermal material radially to cover vegetation surrounding the vertical support.

16. The method of claim 15, further comprising:
Furling the material for storage adjacent the vertical support.

17. The method of claim 16, further comprising:
Sliding the furled material down the support.

18. The method of claim 16, further comprising:
Fixing the material in the furled condition.

19. The method of claim 15, further comprising:
Unfurling the material radially from the support.

20. The method of claim 15, further comprising:
Unfurling the material at an angle downward from the support to a ground surface.
